(19) United States
(12) Patent Application Publication
(10) Pub. No.: US 2024/0165696 A1
(43) Pub. Date: May 23, 2024

(54) MOLTEN METAL FILTER

(71) Applicant: PYROTEK, INC., Spokane, WA (US)

(72) Inventors: Richard S. HENDERSON, Aurora, OH (US); Andrew HALLNAN, Aurora, OH (US)

(21) Appl. No.: 18/282,597

(22) PCT Filed: Mar. 17, 2022
(86) PCT No.: PCT/US22/20763

§ 371 Date: Sep. 18, 2023

Related U.S. Application Data
(60) Provisional application No. 63/162,896, filed on Mar. 18, 2021.

(51) Int. Cl. B22D 11/119; B22D 43/00

(52) U.S. Cl. CPC B22D 11/119; B22D 43/004

(57) ABSTRACT

According to another embodiment, a molten metal filter having two opposed plates is provided. At least one hollow elongated member comprised of a porous refractory material is attached at a first end to a first end plate and at a second end to a second end plate. The first end plate has a passage extending through a width of the first end plate and a ledge that receives the first end of the elongated member. The second end plate has an opening receiving the second end of the elongated member. The opening passes through the width of the second end plate and is dimensioned to be larger than a circumference of the elongated member.

This application claims the benefit of U.S. Provisional Application Ser. No. 63/162,896 filed Mar. 18, 2021, the disclosure of which is incorporated by reference herein.

### BACKGROUND

The present exemplary embodiment relates to a filter. It finds particular application in conjunction with a cartridge filter for use in removing entrained solids from molten metal and will be described with particular reference thereto. However, it is to be appreciated that the present exemplary embodiment is also amenable to other similar applications.

Molten aluminum generally contains entrained solids which are deleterious to the final cast metal product. These entrained solids usually derive from three sources. Some are oxide particles which are drawn into the liquid stream from the floating oxide layer on the surface; some entrained particles are fragments of furnace lining, transfer trough and other portions of the molten aluminum handling equipment which are eroded and entrained in the flowing aluminum stream; and some particles are precipitates of insoluble impurities such as intermetallic compounds, borides, carbides or precipitates of other aluminum compounds, such as aluminum chloride.

When inclusions appear in the final cast product after the molten aluminum is solidified, they cause such final product to be less ductile, have lower strength or to have poor finishing characteristics. Accordingly, it is desirable to remove entrained solids from the molten aluminum before it is cast into a solid body which may be used as such or subjected to forming operations such as rolling, forging, extrusion, etc.

The cartridge filter process removes entrained solids from liquids by passing the solid-laden liquid through a porous, homogenous filter medium upon which a cake forms. Cake formation can be encouraged by introduction of a cake forming additive, such as excess titanium diboride, to the molten metal. Cake formation can be controlled to tailor the filtering process. Typically, the filtration process is terminated when the cake releases.

Filtering molten metal in general, and molten aluminum in particular, creates special problems because the liquid is so aggressive that it is difficult to find a filter medium capable of withstanding the aggressive chemical and thermal environment. In such systems, a filter medium or filter element of a temperature resistant material is used. Preferred materials resist deterioration from melting, chemical reaction with the metal, and erosion at elevated temperatures. The filter medium must also maintain structural integrity at such elevated temperatures and, of course, must either entrap or prevent the flow of solids, and semi-liquids by chemical reactions and/or by mechanical prevention of their flow therethrough.

A variety of means for accomplishing filtration are known to those with skill in the art. Examples of this can be found in U.S. Pat. Nos. 4,964,993; 4,444,377; 4,426,287; 4,413.813; 4,384.888; 4,330,328; 4,330,327; 4,302,502; 4,298,187; 4,258,099; 4,179.102; 4,159,104; 4,081371; 4,032,124; 3,869,282; and 5,126,047 which are herein incorporated by reference. U.S. Pat. No. 5,369,063. herein incorporated by reference, describes a foam filter of alumina which can be formed into a plate. Also utilized in the art are cartridge filters comprised of rectangular end plates interconnected by filtration tubes (see for example U.S. Pat. Nos. 3,747,765 and 5,741,422; the disclosures of which are herein incorporated by reference).

Cartridge filters are often considered superior filters because they possess exceptional throughput, filtration capabilities and longevity. One of the problems inherent in prior cartridge filter designs is a tendency for the end plate at the outlet end of the filter box to crack and allow by-pass of the molten metal without being filtered. The present disclosure provides a cartridge filter having a high degree of structural integrity and excellent filtration characteristics.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

According to a first embodiment, a molten metal filter having two opposed plates and at least one hollow elongated member is provided. The elongated member is formed of a porous refractory material and is attached at a first end to a first end plate and at a second end to a second end plate. The first end plate has a passage extending through a width of the end plate that receives the first end of the elongated member. The second end plate has an opening receiving the second end of the elongated member. The opening in the second end plate includes an element configured to accommodate thermal expansion of the elongated member.

According to another embodiment, a molten metal filter having two opposed plates is provided. At least one hollow elongated member comprised of a porous refractory material is attached at a first end to a first plate and at a second end to a second plate. The first plate has a passage extending through a width of the plate and a ledge in the passage that receives the first end of the elongated member. The second plate has an opening receiving the second end of the elongated member. The opening passes through the width of the second plate and is dimensioned to be larger than a circumference of the elongated member.

According to a further embodiment, a molten metal filter comprising two opposed plates and at least one hollow elongated member extending therebetween is provided. The elongated member and at least a first of the plates is comprised of a porous refractory material. The porous refractory material plate has an opening receiving an end of the elongated member. The opening passes through a width of the plate. At least a portion of a surface of the plate facing the elongated member includes a cement coating.

According to another embodiment, a method of filtering molten metal is provided. The method includes providing a cartridge filter having two opposed plates and at least one hollow elongated member. The elongated member and at least a first of the plates is comprised of a porous refractory material. The first plate has an opening receiving an end of the elongated member. The opening passes through a width of the plate. A portion of a surface of the first plate facing the elongated member includes a cement coating. The cartridge filter is disposed in a filter box having an inlet side and an outlet side. Molten metal is introduced into the inlet side of the filter box such that the molten metal passes to the outlet through the porous refractory material of the elongated member and a portion the first plate that does not include a cement coating.

### BRIEF DESCRIPTION OF THE DRAWINGS

The following is a brief description of the drawings, which are presented for the purposes of illustrating the exemplary embodiments disclosed herein and not for the purposes of limiting the same.

The invention consists of the novel parts, constructions, arrangements, combinations, and improvements shown and described. The accompanying drawings which are incorporated in and constitute a part of the specification illustrate one embodiment of the invention and, together with the description, serve to explain the principles of the invention. Of the drawings:

FIG. 1 is a cross-sectional view of a molten metal cartridge filter assembly according to the prior art;

FIG. 2 is a perspective view of the cartridge filter end plates of the present disclosure;

FIG. 3 is a cross-sectional view of an individual tube as a component of a cartridge filter assembly constructed in accord with the present disclosure;

FIG. 4 is a cross-sectional view of a molten metal cartridge filter end plate passage constructed in accord with an alternative embodiment of the present disclosure;

FIG. 5 is a cross-sectional view of a molten metal cartridge filter end plate passage constructed in accord with a further alternate embodiment of the present disclosure; and

FIG. 6 is a cross-sectional view of a filter box in accord with a further embodiment of the present disclosure.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used herein, the terms about, generally and substantially are intended to encompass structural or numerical modifications which do not significantly affect the purpose of the element or number modified by such term.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

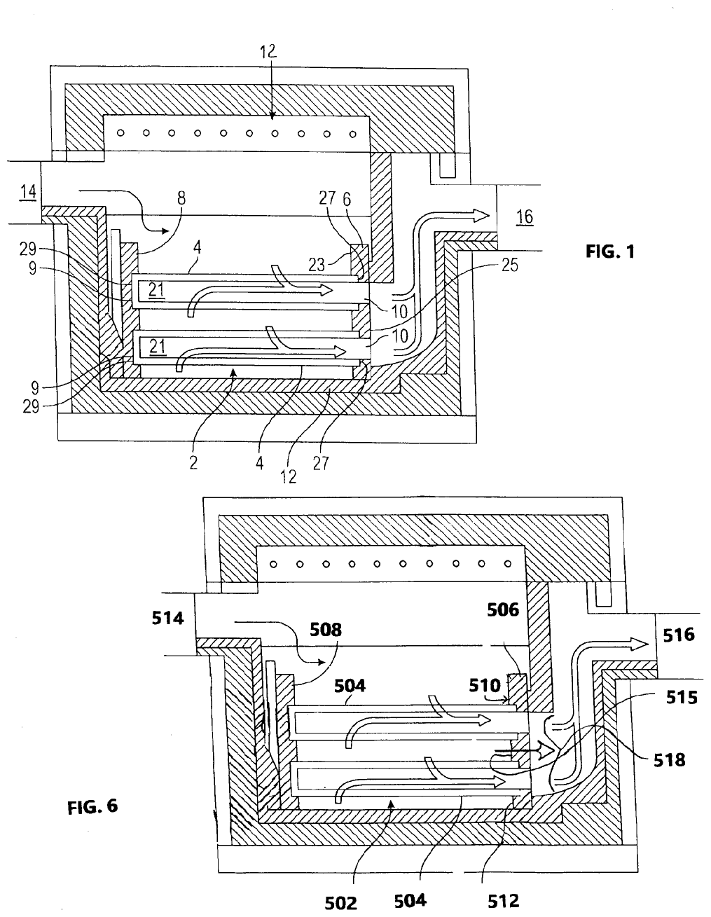

Referring to FIG. 1, a molten metal cartridge filter according to the prior art is indicated by the reference numeral 2. It includes four horizontally oriented cylindrical tubes 4 (only two of which are visible) connected at their ends to a pair of parallel plates 6 and 8. Plate 6 includes openings 10 that communicate with the hollow open ends of tubes 4. Plate 8 includes four recesses 9 that receive a closed end of hollow tubes 4. Heating element 11 can be provided in a lid of the filter box 12.

The filter 2 is disposed in the filter box 12. When molten metal enters the filter box 12 through the inlet 14, it is forced to pass through the tube walls into the hollow tube interiors 21 and through the openings 10 to the outlet 16. Molten metal is filtered as it passes through a cake that forms on the surface of each hollow tube.

Passage 10 extends from the inward face 23 of plate 6 to outward face 25. A ledge 27 is formed in each passage 10 to receive an end of tube 4. Plate 8 includes a recess 29 that receives an opposed end of the tube 4. It has been found that since plate 6 has less material than plate 8 (passages versus recesses), thermal expansion of the tube(s), even when gaskets are employed, is more likely to cause cracking in the plate 6. Cracking of plate 6 can allow the undesirable flow of unfiltered metal from filter box 12 to the outlet 16 and a downstream casting operation.

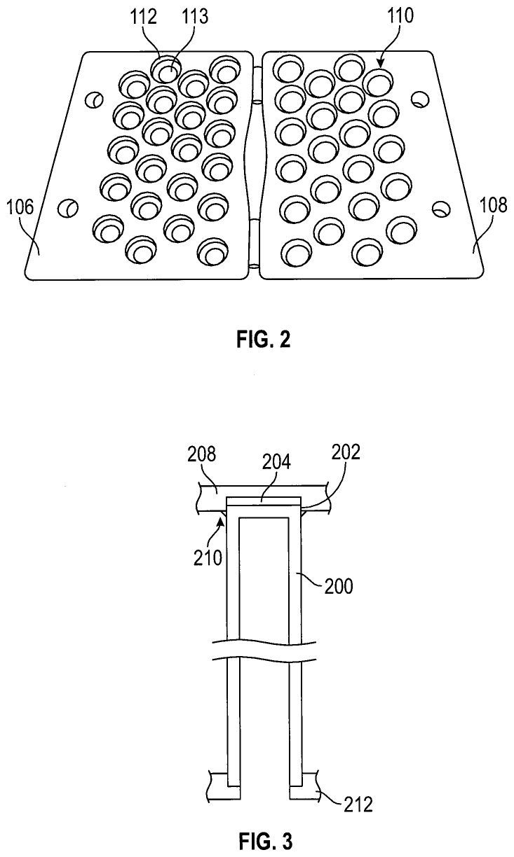

Referring now to FIG. 2, cartridge plate 106 is shown adjacent cartridge plate 108. Cartridge plate 106 is intended to be installed at the outlet side of a filter box and cartridge plate 108 is intended to be positioned at the inlet side of the filter box. In an assembled condition, filtration tubes extend between the plates 106/108. The plates can be constructed of graphite, silicon carbide or ceramic silicate, for example, and the tubes can be constructed of bonded particles of glass, silicon carbide or alumina, for example.

A first closed end of a tube is received in openings 110 and a second open end of the tube in passages 112. Passages 112 pass through the width of cartridge plate 106 but include a ledge 113 that abuts an end of the tubes. Openings 110 pass through the width of plate 108. Openings 110 can have a dimension sufficient to receive the full circumference of the tube throughout the length of the opening. Openings 110 are provided to allow lengthwise thermal expansion of the tubes within the openings. In this regard, although openings 110 are shown as penetrating the full width of the end plate, it is envisioned that the opening is only deep enough to accommodate thermal expansion (see FIG. 3). However, it is noted that an opening that extends fully through the plate may be advantageous in that the end wall of the filter tube becomes an added filtration surface. End plate 108 can be further modified to include an element allowing assembly of the cartridge filter for transport and installation.

Turning now to FIG. 3, one design for permitting construction, transport, installation and thermal expansion of a cartridge filter is illustrated. Particularly, filtration tube 200 is only partially inserted into chamber 202 such that an expansion gap 204 remains. Elongated tube 200 is secured to end plate 208 using a fillet of cement 210. The opposed end of elongated tube 200 is cemented into a passage in end plate 212. The quantity of cement is selected to provide sufficient structural integrity of the assembled cartridge filter to allow transport and installation but preferential breaking of at the fillet when thermal expansion occurs.

In this regard, the quantity of cement used should create a joint with less structural integrity than end plate 106. Moreover, fillet 210 is minimal, allowing the fillet to crack upon expansion in the length of elongated tube 206, such that the end of the tube expands into expansion gap 204 rather than cracking either end plate. In this context, the fillet of cement can be thin or discontinuous throughout the circumference of the tube or both.

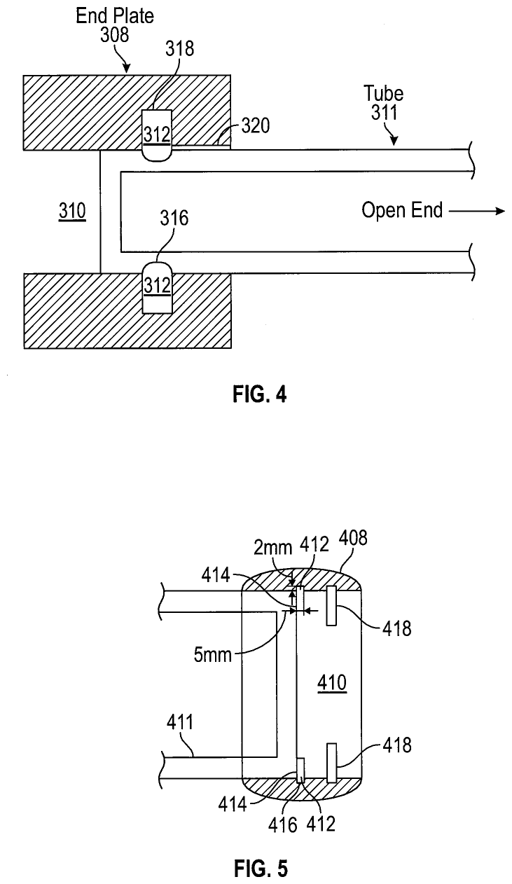

Turning now to FIG. 4, an alternate embodiment is illustrated. In this embodiment, the inlet side end plate 308 includes openings 310 (only one being illustrated) that pass fully through the width of the end plate. The dimensions of the opening 310 will be large enough to facilitate insertion of the closed end of filter tube 311. The opening is further equipped with at least one tab 312. Tab 312 can be a unit of cement. The cement can be applied as a coating on one or both of the surface of the opening 310 or the tube 311. Upon insertion of the tube into the opening, the cement can flow into recesses 316 in the tube and 318 in the end plate to form the tab 312 after hardening.

Alternatively, or additionally, a groove 320 (or multiple grooves) can be provided to allow cement injection into the recess 318. The recess can be of any shape, (e.g. circular or rectangular). Similarly, it is noted that the recess can be continuous throughout the circumference of the tube end plate interface or discontinuous.

Turning now to FIG. 5, a further alternative embodiment is illustrated. In this embodiment, filter tube 411 is again inserted into a passage 410 formed in end plate 408. A tab 412 receives an end section 414 of closed end filter tube 411. The interface between filter tube 411 and tab 412 can be secured by cement. Once thermal expansion of filter tube 411 occurs and it penetrates further into passage 410, tab 412 fractures or dislocates allowing the end section 414 to expand deeper into the passage. In some embodiments, expanding may be sufficient such that the end section 414 of filter tube 411 abuts a second tab 418.

In any of the above embodiments, the tab can be configured of a size, material and/or design that breaks during thermal expansion of the tube, allowing the tube to penetrate further into the opening without cracking the end plate. For example, the tab 412 can have a thickness (5 mm is illustrated) that will preferentially break. Alternatively, the tab 412 can be received in a minimal detent 416 to allow dislocation of the tab from the end plate during thermal expansion of the filter tube. As a further alternative, the tab can be constructed of a material that dissolves in the molten metal, such as aluminum or magnesium.

The filter tubes can be circular in cross-section, although the cross-sectional configuration is not critical and other shapes can be selected if desired. However, it may be advantageous if the end plate recess is shaped at least generally similar. Interposed between the surface of the plate and each tube can be a compressible, aluminum-compatible sealant material, such as a gasket of Fiberfrax which is an alumina-silica fibrous sheet material useful at temperatures above 2,000° F. (sold by Pyrotek Inc.).

Referring now to the embodiments of FIG. 6, a cartridge filter 502 is provided wherein cylindrical tubes 504 extend between two opposed endplates 506 and 508. The cylindrical tubes and at least end plate 506 can be comprised of a porous refractory material.

In one embodiment, at least substantially the entire interior surface of endplate 506 is coated (e.g. regions 510, 512 and 515) with a refractory cement. Moreover, the interior surface of endplate 506 that is not interrupted by a tube 504 can include the coating.

Advantageously, it has been found that the cement coated bonded particle plates of the present disclosure can be less expensive and stronger than traditional plates formed of castable silicon carbide or castable alumina silicon carbide. In this manner a less expensive endplate that is less likely to experience cracking from thermal expansion is provided.

Alternatively, a portion of a surface of the end plate 506 facing the tubes includes a cement coating while a portion suitable for filtering molten metal as it passes to outlet 516 does not include the cement coating. For example, regions 510 and 512 can include the cement coating. Region 515 will not include the cement coating. This design allows molten metal to flow through the end plate 506 at region 515 to outlet 516.

Moreover, while the cement coated portions are configured to prevent molten metal from entering the bonded particle material, the uncoated region(s) increase the surface area available for filtration and improves the efficiency of the cartridge filter. The coated region(s) prevent molten metal flow to undesirable areas of the filter box and provide a significant increase in endplate strength to resist thermal expansion cracking.

In this context, a viable configuration would be to coat end plate 506 on its interior surface and optionally the exterior surface at any location not aligned with the opening 518 to outlet 516. Plate 508 can be coated on an interior surface and optionally an exterior surface.

An exemplary cement coating will have a thickness between about 1 millimeter and 5 millimeters. Exemplary cements are those having high temperature resistance and low CTE, such as sodium silicate/clay or alumina silica/clay systems. A suitable cement can be Frakset® cement available from Pyrotek, Inc.

Plate 506 (optionally plate 508) and the tubes can be comprised of bonded particles of glass-bonded particles of silicon carbide or bonded particles of aluminum oxide. The particles can bound together using a binder such as CaO—Al₂O₃—B₂O₃ and MgO—Al₂O₃—B₂O₃.

The particles forming the plate can have a grain size equal to or smaller than the particles forming the elongated tube. In this manner molten metal will pass though the tubes at a rate equal to or higher than endplate 506.

According to the embodiment of FIG. 6, the method of filtering molten metal allows introducing molten metal to the inlet side 514 of the filter box such that the molten metal passes to the outlet through the porous refractory material of the elongated members 504 and region 515 (if uncoated) of the porous refractory material of the first plate 506.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

1. A molten metal filter comprising two opposed plates and at least one hollow elongated member comprised of a porous refractory material attached at a first end to a first end plate and at a second end to a second end plate, the first end plate having a passage extending through a width of the end plate that receives the first end of the elongated member, the second end plate having an opening receiving the second end of the elongated member, wherein the second end plate includes an element configured to accommodate thermal expansion of the elongated member.

2. The molten metal filter of claim 1 wherein the element comprises a tab disposed in the opening.

3. The molten metal filter of claim 1 wherein the element comprises a fillet of cement disposed in or adjacent the opening.

4. The molten metal filter of claim 1 wherein the passage comprising a recess conformed to receive the first end of the elongated member.

5. The molten metal filter of claim 1 wherein the opening extends through a width of the second end plate and is sized to accommodate the second end of the elongated member.

6. The molten metal filter of claim 1 comprised of multiple elongated members, passages and openings.

7. The filter of claim 1 wherein the elongated member is comprised of bonded alumina oxide.

8. The filter of claim 1 wherein the end plates are comprised of graphite or silicon carbide and/or alumina silicon carbide.

9. The filter of claim 1 wherein the second end of the elongated member is closed.

10. The molten metal filter of claim 1 wherein the passage in the first end plate is configured to be the same as the opening in the second end plate.

11. A molten metal filter comprising two opposed plates and at least one hollow elongated member comprised of a porous refractory material attached at a first end to a first plate and at a second end to a second plate, the first plate having a passage extending through a width of the plate and a ledge in the passage that receives the first end of the elongated member, the second plate having an opening receiving the second end of the elongated member, the opening passing through a width of the second plate, said opening being dimensioned to be larger than a circumference of the elongated member.

12. The molten metal filter of claim 11 wherein the first end of the elongated member is open and the second end of the elongated member is closed.

13. A molten metal filter comprising two opposed plates and at least one hollow elongated member extending therebetween, the elongated member and at least a first of the plates being comprised of a porous refractory material, said porous refractory material plate having an opening receiving an end of the elongated member, said opening passing through a width of the plate, wherein an entire surface of the plate facing the elongated member includes a cement coating or wherein a periphery of the surface includes a cement coating and a middle portion of the surface is uncoated.

14. (canceled)

15. (canceled)

16. The filter of claim 13 wherein the first plate and the elongated member are comprised of glass bonded particles or, silicon carbide or aluminum oxide.

17. The filter of claim 16 wherein the porous refractory material includes a binder selected from CaO—Al2O3 and MgO—Al2O3-B2O3.

18. The filter of claim 16 wherein the particles forming the first plate have a grain size equal to or smaller than the particles forming the elongated tube.

19. The filter of claim 13 wherein the cement is comprised of sodium silicate and clay.

20. The filter of claim 13 wherein a second of the opposed plates is comprised of bonded particles and includes a surface facing the elongated member, said surface including an at least substantially complete coverage of the cement coating.

21. The filter of claim 20 wherein an exterior surface of the second plate includes a cement coating and an exterior surface of the first plate includes a cement coating corresponding in location to the interior surface coating.

22. A method of filtering molten metal comprising providing the cartridge filter of claim 1, said cartridge filter being disposed in a filter box having an inlet side and an outlet side, introducing molten metal into the inlet side of the filter box such that said molten metal passes to the outlet through the porous refractory material of the elongated member and a portion of the porous refractory material of the first plate that does not include a cement coating.

23. (canceled)
